(19) United States
(12) Patent Application Publication
(10) Pub. No.: US 2005/0018055 A1
(43) Pub. Date: Jan. 27, 2005

(54) FILE MANAGING METHOD FOR AN IMAGE CAPTURING APPARATUS

(76) Inventors: Tzu-Hung Cheng, Taipei City (TW); Chen-Ning Hsi, Taipei City (TW)

Correspondence Address: NAIPO (NORTH AMERICA INTERNATIONAL PATENT OFFICE), P.O. BOX 506, MERRIFIELD, VA, 22116, US

(21) Appl. No.: 10/605,655

(22) Filed: Oct. 15, 2003

(30) Foreign Application Priority Data
Jul. 23, 2003 (TW) 092120146

(51) Int. Cl. H04N 5/76; G06F 7/00; G06F 17/00

(52) U.S. Cl. 348/231.2; 707/104.1

(57) ABSTRACT

A file managing method for an image capturing apparatus includes selecting at least one image from a plurality of images captured by the image capturing apparatus as a directory name of the plurality of images.

### BACKGROUND OF INVENTION

1. Field of the Invention

The present invention relates to a file managing method for an image capturing apparatus, and more specifically, to a file managing method using images captured by an image capturing apparatus as directory names of those images.

2. Description of the Prior Art

As the information industry progresses, information-related products are increasingly used in daily life and conventional analog products are gradually being replaced by digital products. Take the digital camera as an example, conventional film cameras utilize chemicals on a film to record images, which can be viewed after development. Moreover, if a user wants to take pictures with special effects, the user is required to be skillful in controlling the stop, the shutter as well as the lens and film development, which is inconvenient for an amateur. In contrast to the conventional film cameras, digital cameras convert images into digital signals by a photo sensor to directly store them into a memory device in image format compatible with a computer. Digital cameras can also be connected to a computer system and store images on its hard disk drive. The images can then be viewed on a screen or printed on a printer. In addition, the user can further process the images recorded by the digital camera using image processing software to produce special effects, which previously could only be realized by a professional photographer with a conventional optical camera, or perhaps even could not be achieved using a conventional optical camera.

Please refer to FIG. 1 showing a front view of a conventional digital camera 10. The digital camera 10 includes a lens 12 for capturing an object, an optical viewfinder 14 for viewing the object, and a shutter button 16 for focusing and shooting. Please refer to FIG. 2 showing a rear view of the conventional digital camera 10. The digital camera 10 further includes an electrical viewfinder 18 providing another option for viewing the object, which could be a liquid crystal display (LCD) or a low temperature polysilicon (LTPS) display, and a control button set 20 for image editing, browsing, and parameter settings. The difference between the conventional digital camera 10 and a conventional film camera is that the digital camera 10 provides the electrical viewfinder 18 for viewing the object or images captured instead of the optical viewfinder 14 which is smaller in size. Additionally, the user can browse images captured by the electrical viewfinder 18 to decide whether to delete them or not.

Although digital cameras are becoming more popular every day, it is inconvenient to manage the captured images. That is because every time after the digital camera 10 captures an image, it will give the image a file name numbered sequentially and automatically instead of named by the user. Please refer to FIG. 3 showing the captured images shown by the electrical viewfinder 18 of the conventional digital camera 10 in FIG. 2. Assume that the user takes pictures in London (P001-P003 in FIG. 3) on the first day, in Paris (P004-P007 in FIG. 3) on the second day, and in Berlin (P008-P009 in FIG. 3) on the third day. Whenever the user wants to find the pictures taken in Berlin, it is required to browse the captured images one by one until P008-P009 are found, which indeed causes time to be wasted.

Regarding this problem, conventional digital cameras provide a means to establish file directory names for users to collect captured images under different directories. However, the conventional digital camera 10 does not provide a keyboard so that it is inconvenient to name the images alphabetically instead of numerically. For instance, the user can collect the images captured in London under directory 1, the images captured in Paris under directory 2, and the images captured in Berlin under directory 3. This file managing method can reduce time searching images, for example, the user can choose directory 2 and then search for the pictures taken in front of the Arc of Triumph, however, numerical directory names may confuse users.

### SUMMARY OF INVENTION

It is therefore a primary objective of the present invention to provide a file managing method using captured images for users to search and manage those captured images, in order to solve the problems mentioned above.

Briefly summarized, a file managing method for an image capturing apparatus includes selecting at least one image from a plurality of images captured by the image capturing apparatus as a directory name of the plurality of images.

It is an advantage of the present invention that after setting, the image as the directory name, the user can find required images rapidly by the directory name instead of searching one by one as in the prior art.

It is another advantage of the present invention that any of the images in the directory can replace the original directory name according to user″s preference.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a front view of a conventional digital camera.

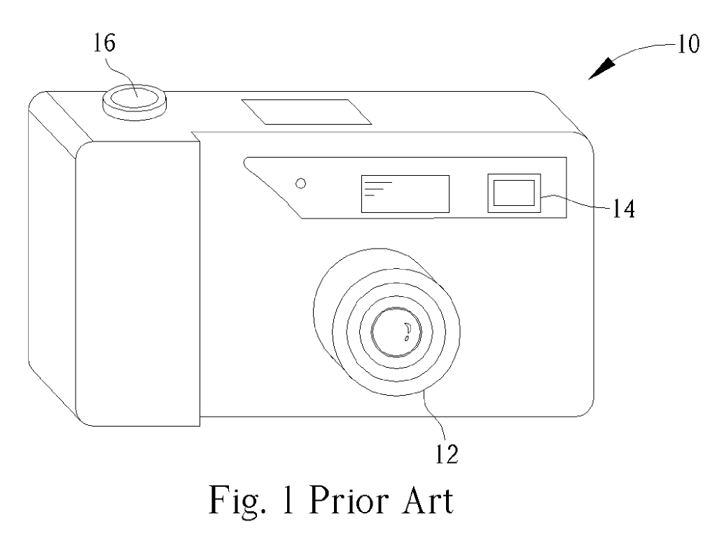

FIG. 2 is a rear view of the conventional digital camera.

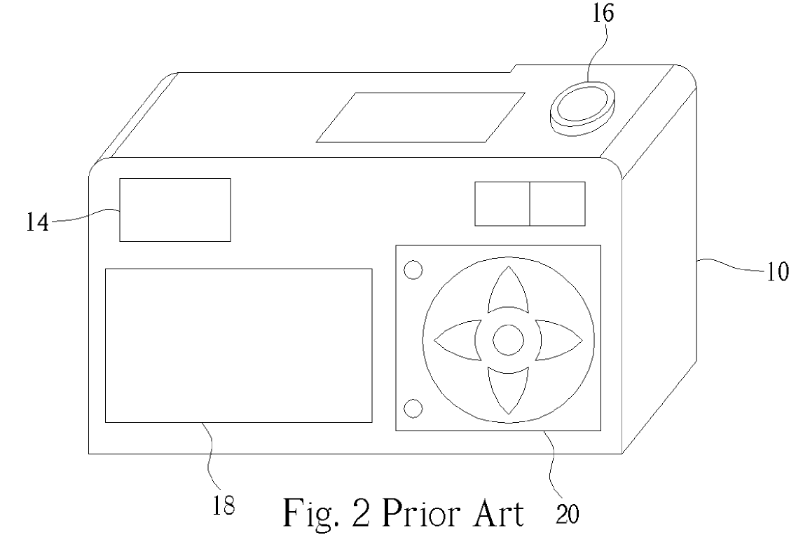

FIG. 3 illustrates the captured images shown by the electrical viewfinder of the conventional digital camera in FIG. 2.

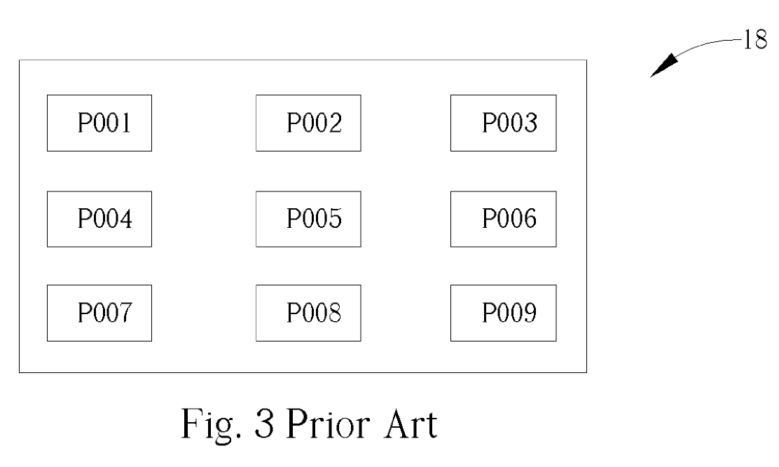

FIG. 4 is a front view of an image capturing apparatus according to the present invention.

FIG. 5 is a rear view of an image capturing apparatus according to the present invention.

FIG. 6 is a flowchart of the file managing method for the image capturing apparatus according to the present invention.

FIG. 7 illustrates a directory structure of the method according to the present invention.

### DETAILED DESCRIPTION

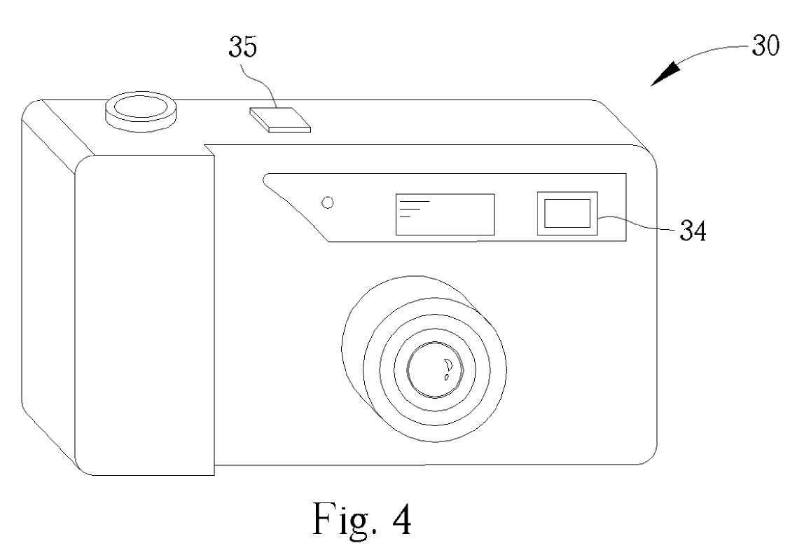

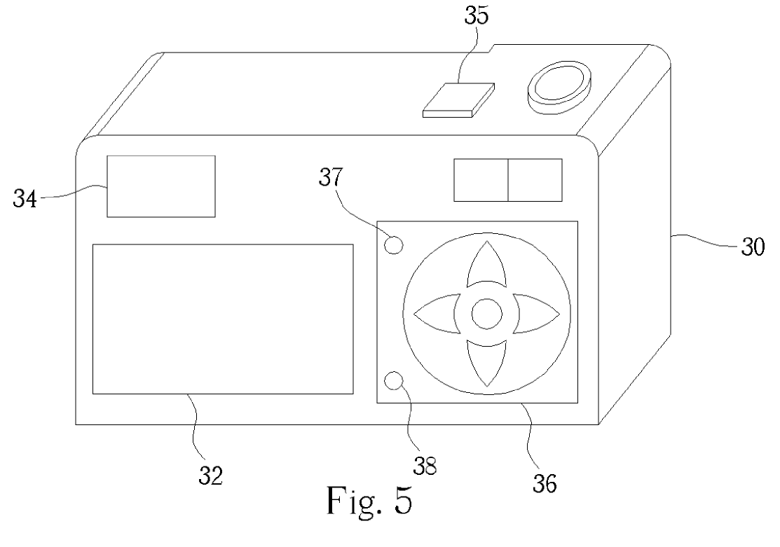

Please refer to FIG. 4 showing a front view of an image capturing apparatus 30 according to the present invention, and FIG. 5 showing a rear view of the image capturing apparatus 30. The image capturing apparatus 30 can be a digital camera or a digital camcorder. The image capturing apparatus 30 includes an optical viewfinder 34 for viewing the object, an electrical viewfinder 32 providing another option for viewing the object, which can be a LCD or a LTPS display, a power button 35 for turning on the image capturing apparatus 30, and a control button set 36 for image editing, browsing, and parameter settings. The control button set 36 has a setting button 37 and a control button 38. The setting button 37 is for setting a directory name of a first captured image, and the control button 38 is for setting a directory name of one of a plurality of captured images.

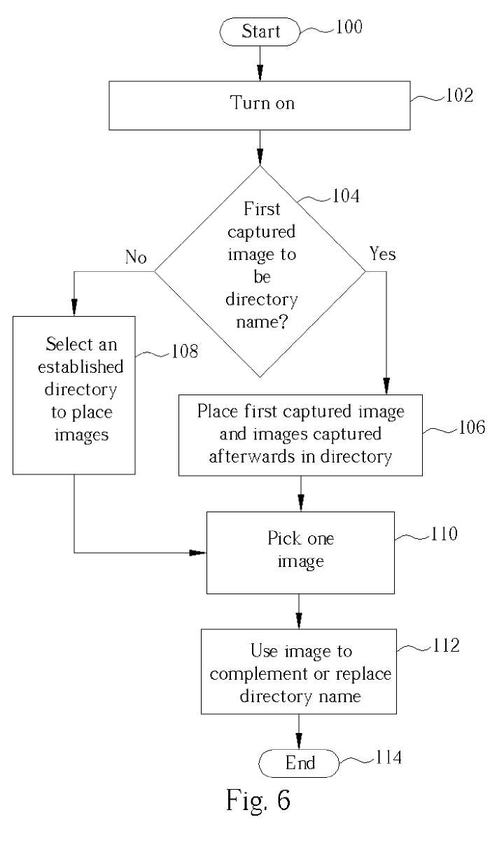

Concerning the improved method provided by the present invention, please refer to FIG. 6 showing a flowchart of the file managing method for the image capturing apparatus according to the present invention as follows:

Step100: Start.

Step102: Press the power button 35 to turn on the image capturing apparatus 30.

Step104: Determine whether to set up the first captured image after the image capturing apparatus 30 turns on as a directory name. If yes then proceed to Step106, otherwise proceed to Step108.

Step106: Place the first image and the plurality of images captured after the directory is established in the directory.

Step108: Select one of the established directories and place images captured by the image capturing apparatus 30 in the selected directory.

Step110: Pick one of the plurality of images in the directory by the image capturing apparatus 30.

Step112: Use the image picked in step 110 to complement or replace the directory name of the plurality of images.

Step114: End.

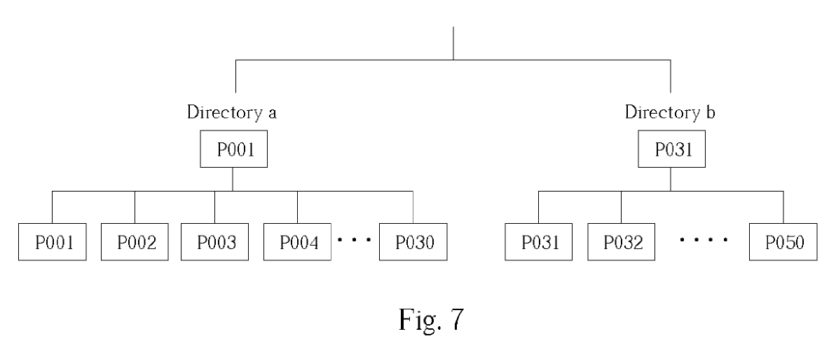

For a further description, please refer to FIG. 6 as well as FIG. 7 showing the directory structure of the method according to the present invention. After the power button 35 is pressed, the image capturing apparatus 30 is turned on (as described in Step102). For example, if the user turns on the image capturing apparatus in London, the user can determine whether to designate the first captured image as the directory name using the setting button 37 of the control button set 36. If yes, the image capturing apparatus 30 will use the first image (image P001 in FIG. 7) as the name of directory a (as described in Step104). In other words, the name of directory a will be image P001 instead of letters or numbers. If no, the user can use the control button set 36 to select one of the established directory names, so that the image capturing apparatus 30 will place the images captured afterwards in the selected directory (as described in Step108). The image capturing apparatus 30 places all images captured by the user (P001-P003 in FIG. 7) under directory a (as described in Step106). If the user finishes the part of the journey in London and turns off the image capturing apparatus 30 when leaving for the next destination Paris, when the power button 35 is pressed again, the first captured image (P031 in FIG. 7) will be the name of another directory b. Image P031 and images captured afterwards (P032-P050 in FIG. 7) will be placed under directory b. When the user browses the images, the topics of the images can be found according to the names (image P001 and image P031) of directory a and b. However, if the user does not want image P001 to represent directory a, all the images under directory a can be browsed (as described in Step110) and preferred image P015 can be selected by the control button 38 of the control button set 36. In this situation, the name of directory a will be replaced from P001 to P015. Alternatively, when the user captures a new image P018, the control button 38 can be used to replace P001 to become the name of directory a (as described in Step110). Please notice that the directory name does not necessarily need to be composed by only one image. If the user prefers image P020, both image P015 and image P020 can be set as the name of directory a by double clicking the control button 38. And of course, the directory name can also be composed of two or more images. In such a manner, the user can find a required image rapidly using the directory names. For instance, the user can select a picture taken in front of the Arc of Triumph as the name of directory b which stores the pictures in Paris. When finding the pictures taken in front of the Louvre, the directory with the Arc of Triumph can be opened as its name instead of searching images one by one as in the prior art.

The method according to the present invention can also be applied in digital camcorders. Although a digital camcorder records motion pictures, a single image can be selected to be a directory name.

In contrast to the prior art, the file managing method according to the present invention is to select one of the captured images as a directory name for users to find required images rapidly with the help of the directory name, instead of searching images one by one or remembering directory names in number as in the prior art. Thus, the method according to the present invention is an improvement over the method of the prior art.

Those skilled in the art will readily observe that numerous modifications and alterations of the method may be made while retaining the teachings of the invention. Accordingly, the above disclosure should be construed as limited only by the metes and bounds of the appended claims.

1. A file managing method for an image capturing apparatus, the method comprising:
selecting at least one image from a plurality of images captured by the image capturing apparatus as a directory name of the plurality of images.

2. The method of claim 1, further comprising classifying the plurality of images using the directory name.

3. The method of claim 1, further comprising determining whether to set up a first image captured after the image capturing apparatus is turned on as the directory name.

4. The method of claim 1, further comprising selecting other images from the plurality of images to become the directory name of the plurality of images.

5. The method of claim 1, wherein the image capturing apparatus is a digital camera or a digital camcorder.

6. An image capturing apparatus for implementing the method of claim 1.

7. An image capturing apparatus comprising:
a viewfinder for viewing an object; and
a control button set for controlling relating functions of the image capturing apparatus, the control button set comprising a control button for selecting at least one image from a plurality of images captured by the image capturing apparatus as a directory name of the plurality of images.

8. The image capturing apparatus of claim 7, further comprising a power button for turning on the image capturing apparatus.

9. The image capturing apparatus of claim 8, wherein the control button set further comprises a setting button for selecting a first image captured after the image capturing apparatus is turned on as the directory name.

10. The image capturing apparatus of claim 7, wherein the viewfinder is an electrical viewfinder.

11. The image capturing apparatus of claim 7 being a digital camera or a digital camcorder.
